(19) United States
(12) Patent Application Publication
(10) Pub. No.: US 2021/0130237 A1
(43) Pub. Date: May 6, 2021

(54) MANUFACTURING METHOD FOR MOLD ADHESIVE, MANUFACTURING METHOD FOR MOLD, AND MOLD

(71) Applicant: TOYOTA JIDOSHA KABUSHIKI KAISHA, Toyota-shi (JP)

(72) Inventors: Masaomi MITSUTAKE, Nissin-shi (JP); Hirotsune WATANABE, Miyoshi-shi (JP)

(73) Assignee: TOYOTA JIDOSHA KABUSHIKI KAISHA, Toyota-shi (JP)

(21) Appl. No.: 16/928,482

(22) Filed: Jul. 14, 2020

(30) Foreign Application Priority Data
Nov. 6, 2019 (JP) 2019-201237

(51) Int. Cl. C04B 28/26; B29C 65/48

(52) U.S. Cl. CPC C04B 28/26; C04B 2111/00939; B29C 65/485

(57) ABSTRACT

A manufacturing method for a mold adhesive according to an aspect of the disclosure includes a step of preparing aqueous solution containing water glass, a step of heating the aqueous solution to 90° C. or higher but not exceeding 100° C., and a step of extracting gelled water glass as the mold adhesive, the gelled water glass being separated on a liquid surface of the heated aqueous solution. A solid component of the prepared aqueous solution falls within a range of 25 mass % or higher but not exceeding 35 mass %.

### INCORPORATION BY REFERENCE

The disclosure of Japanese Patent Application No. 2019-201237 filed on Nov. 6, 2019 including the specification, drawings and abstract is incorporated herein by reference in its entirety.

### BACKGROUND

### 1. Technical Field

The disclosure relates to a manufacturing method for a mold adhesive, a manufacturing method for a mold, and the mold.

### 2. Description of Related Art

A technology has been known by which a plurality of mold parts is adhered with an adhesive so as to manufacture a mold. As the mold parts are adhered to each other with the adhesive, it is possible to manufacture the mold having a desired shape.

Japanese Unexamined Patent Application Publication (Translation of PCT application) No. 2017-508824 (JP 2017-508824 A) discloses a technology related to a mold adhesive containing water glass and an organic substance.

### SUMMARY

Sand used for a mold can be reused as reclamation treatment is performed after the mold is used. For example, a mold that is manufactured with use of water glass as binder is reused as treatment for removing the water glass is performed after the mold is used so that reconditioned sand is generated.

However, when the mold parts are adhered with an adhesive in order to manufacture a mold, if the adhesive used contains impurities (such as organic substances) other than the water glass, it is necessary to separately perform treatment of removing the impurities other than the water glass, and the process of the sand reclamation becomes complex.

Meanwhile, when only water glass is used for the adhesive, treatment for removing impurities other than the water glass is unnecessary. However, in this case, it is necessary to perform thermal treatment in order to thermally cure the water glass when the molds are adhered to each other, and there is a problem that an adhering step in which the molds are adhered to each other is complex.

Therefore, there is a demand for a mold adhesive with which the reclamation treatment for the mold is performed easily, and the adhering step for the molds is performed easily.

In view of the foregoing issue, an object of the disclosure is to provide a manufacturing method for a mold adhesive, a manufacturing method for a mold, and the mold by which reclamation for the mold is performed easily, and an adhering step for the molds is performed easily.

A manufacturing method for a mold adhesive according to an aspect of the disclosure includes a step of preparing aqueous solution containing water glass, a step of heating the aqueous solution to 90° C. or higher but not exceeding 100° C., and a step of extracting gelled water glass as the mold adhesive, the gelled water glass being separated on a liquid surface of the heated aqueous solution. A solid component of the prepared aqueous solution falls within a range of 25 mass % or higher but not exceeding 35 mass %.

With the foregoing manufacturing method for the mold adhesive, the mold adhesive is manufactured with use of the aqueous solution containing the water glass as a raw material. Therefore, when the adhered mold is reused, it is only necessary to perform treatment of removing the water glass, and treatment of removing impurities other than the water glass is not necessary. Therefore, it is possible to perform reclamation for the mold easily. Also, with the above-described manufacturing method for the mold adhesive, since the mold adhesive (the gelled water glass) is manufactured with use of the water glass, it is not necessary to perform thermal treatment when the castings are adhered to each other. Therefore, it is possible to simplify the adhering step for the molds.

In the foregoing manufacturing method for the mold adhesive, the solid component of the prepared aqueous solution may fall within a range of 28 mass % or higher but not exceeding 32 mass %. As a range of the solid component of the aqueous solution is set to the above range, viscosity of the aqueous solution is able to fall within an adequate range. This makes it possible to promote separation of the gelled water glass (the mold adhesive).

In the foregoing manufacturing method for the mold adhesive, in the foregoing heating step, the aqueous solution may be heated in a state where the liquid surface of the aqueous solution is in contact with air. Thus, evaporation of water is promoted on the liquid surface of the aqueous solution, and a dehydration condensation reaction of the water glass is promoted. Therefore, generation of the gelatinized water glass (the mold adhesive) is promoted on the liquid surface of the aqueous solution.

In the foregoing manufacturing method for the mold adhesive, the aqueous solution may be prepared as water glass No. 3 specified in JISK1408 is diluted with water. With use of this method, viscosity of the aqueous solution is able to fall within an adequate range. Thus, it is possible to promote separation of the gelled water glass (the mold adhesive).

A manufacturing method for a mold according to an aspect of the disclosure includes a step of preparing a first mold and a second mold manufactured with use of water glass as binder, a step of applying the mold adhesive to at least either a first adhering surface of the first mold or a second adhering surface of the second mold, the mold adhesive being manufactured with use of the foregoing manufacturing method for the mold adhesive, and a step of manufacturing the mold in which the first adhering surface and the second adhering surface are closely fitted to each other and dried for a given period of time so that the first mold and the second mold are adhered to each other.

A mold according to an aspect of the disclosure is a mold manufactured with use of the foregoing manufacturing method for the mold.

In the foregoing manufacturing method for the mold, and the mold, the first mold and the second mold are adhered to each other with use of the mold adhesive manufactured with use of the water glass as a raw material. Therefore, when the adhered mold is reused, it is only necessary to perform treatment of removing the water glass, and it is not necessary to perform treatment of removing impurities other than the water glass.

Therefore, it is possible to perform reclamation treatment for the mold easily. Also, since the foregoing mold adhesive is used, thermal treatment is not necessary when the castings are adhered to each other. Therefore, it is possible to simplify the adhering step for the molds.

With the disclosure, it is possible to provide the manufacturing method for the mold adhesive, the manufacturing method for the mold, and the mold by which the reclamation treatment for the mold is performed easily, and the adhering step for the molds is performed easily.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view describing a manufacturing method for a mold adhesive according to an embodiment; and

FIG. 2 is a view describing a manufacturing method for a mold according to the embodiment.

### DETAILED DESCRIPTION OF EMBODIMENTS

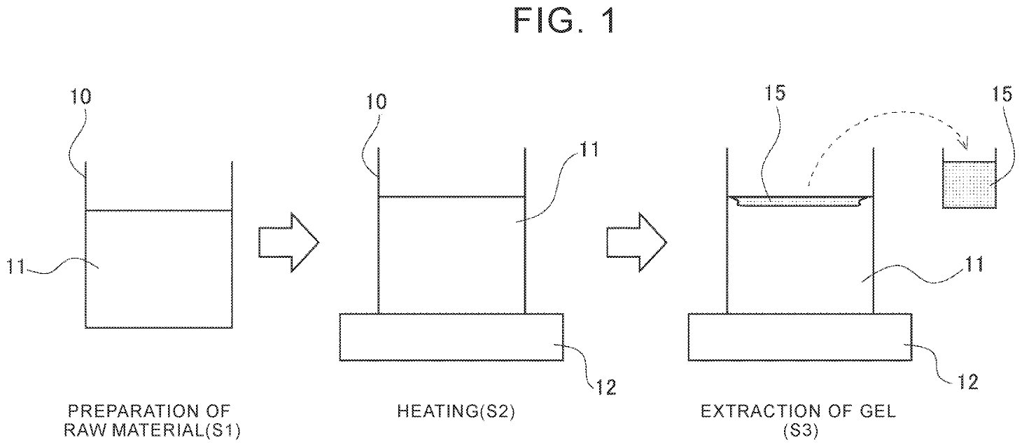

Hereinbelow, an embodiment of the disclosure is described with reference to the drawings. FIG. 1 is a view describing a manufacturing method for a mold adhesive according to an embodiment. As shown in FIG. 1, the manufacturing method for the mold adhesive according to the embodiment includes a step of preparing aqueous solution 11 containing water glass (step S1), a step of heating the aqueous solution 11 to 90° C. or higher but not exceeding 100° C. (step S2), and a step of extracting gelled water glass 15 as the mold adhesive, the gelled water glass 15 being separated on a liquid surface of the heated aqueous solution 11 (step S3). Hereinafter, each of the steps is described in detail.

In the manufacturing method for the mold adhesive according to the embodiment, first of all, the aqueous solution 11 containing the water glass is prepared (step S1). The aqueous solution 11 containing the water glass is stored in a container 10 in which an upper portion is open. The water glass is a mixture containing sodium oxide (Na₂O) and silicon dioxide (SiO₂), and, in the embodiment, the aqueous solution 11 containing the water glass is prepared as water is added to the water glass.

It is preferred that a solid component of the aqueous solution 11 that is prepared in this case is 25 mass % or higher but not exceeding 35 mass %, and a solid component of 28 mass % or higher but not exceeding 32 mass % is more preferred, and a solid component of 30 mass % is most preferred. Here, the solid component of the aqueous solution is a mass ratio of sodium oxide (Na₂O) and silicon dioxide (SiO₂) to water. As the solid component of the aqueous solution 11 falls within the foregoing range, viscosity of the aqueous solution 11 falls within an adequate range. Therefore, separation of the gelled water glass 15 is promoted.

When the solid component (viscosity) of the aqueous solution 11 containing the water glass is too high, agitation or the like of the aqueous solution 11 is not performed properly in the heating step (step S2), and generation of the gelled water glass 15 is thus inhibited. Further, when the solid component (viscosity) of the aqueous solution 11 containing the water glass is too low, the percentage of the water glass in the aqueous solution 11 is low, and generation of the gelled water glass is inhibited. Therefore, the solid component (viscosity) of the aqueous solution 11 containing the water glass needs to fall within an adequate range (the foregoing range).

For example, in the embodiment, it is possible to prepare the aqueous solution 11 as water glass No. 3 specified in JISK1408 is diluted with water. As water glass No. 3 specified in JISK1408 is diluted with water, it is possible to prepare aqueous solution having the foregoing solid component (viscosity).

In the embodiment, since it is assumed that the mold will be reused after being used, aqueous solution containing only the water glass is used when the mold adhesive is manufactured. In this case, the water glass may contain inevitable impurities.

Thereafter, in step S2, the aqueous solution 11 is heated to 90° C. or higher but not exceeding 100° C., or preferably to 95° C. or higher but not exceeding 100° C. For example, as shown in FIG. 1, it is possible to heat the aqueous solution 11 as the container 10 filled with the aqueous solution 11 is placed on heating means 12. At this time, it is preferred that the aqueous solution 11 is heated while being agitated. For example, it is possible to agitate the aqueous solution 11 as a stirrer is sunk to the bottom of the container 10 and rotated with magnetic force. This means that the aqueous solution 11 may be agitated with use of a magnetic stirrer. In this case, a magnetic stirrer provided with heating means may be used.

As the aqueous solution 11 containing the water glass is heated to 90° C. or higher but not exceeding 100° C., a dehydration condensation reaction accelerates and the aqueous solution 11 is gelatinized. This means that there is an OH group in an end of each molecule of the water glass, and the OH group in the end of the molecule has the dehydration condensation reaction. Specifically, an O-ion and an H-ion of the OH group in the end of the one of the molecules of the water glass, and an H-ion of the OH group of another molecule react and are bonded, and one water molecule is formed. Due to this dehydration condensation reaction, an Si—O network is formed in the water glass and the aqueous solution 11 is thus gelatinized.

At this time, as the aqueous solution 11 is heated while the liquid surface of the aqueous solution 11 is in contact with air, evaporation of water is promoted on the liquid surface of the aqueous solution 11, and the dehydration condensation reaction of the water glass is thus promoted. Accordingly, generation of gelatinized water glass is promoted on the liquid surface of the aqueous solution 11 (an interface between the aqueous solution 11 and air).

In the embodiment, in order to promote evaporation of water from the liquid surface of the aqueous solution 11, air blowing means or intake means may be provided near the liquid surface (the interface) of the aqueous solution 11.

Thereafter, in step S3, the gelled water glass 15 separated on the liquid surface of the heated aqueous solution 11 is extracted as the mold adhesive (hereinafter, also referred to as a mold adhesive 15). A method for extracting the gelled water glass 15 may be an arbitrary method. For example, the gelled water glass 15 may be extracted by being pulled up with a bar-shaped member. Further, the gelled water glass 15 may be extracted with use of suction means such as a syringe.

With steps S1 to S3, the mold adhesive is manufactured. The mold adhesive 15 may be stored in a container (a sealed container) in which the adhesive is prevented from being dried.

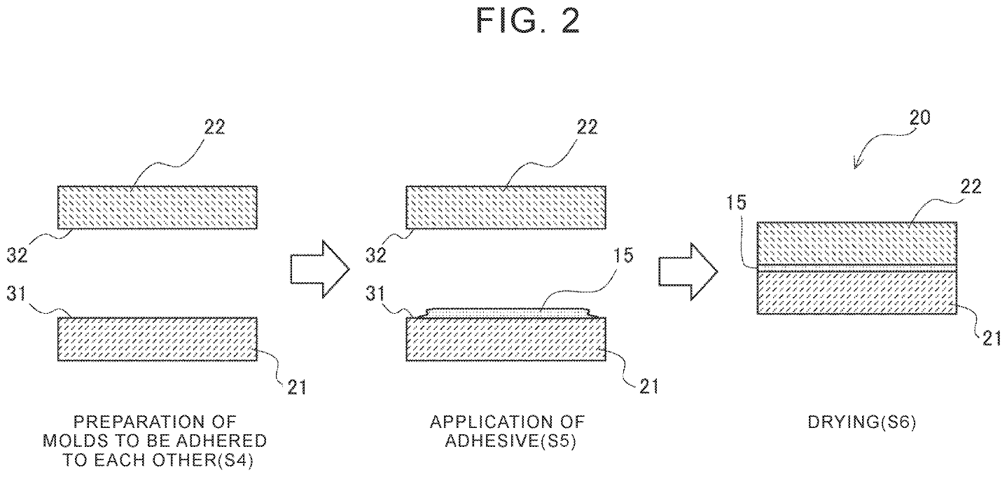

Next, a manufacturing method for the mold according to the embodiment is described. FIG. 2 is a view describing the manufacturing method for the mold according to the embodiment. In FIG. 2, a case is described as an example in which a mold 20 is manufactured as a mold (part) 21 and a mold (part) 22 are adhered to each other.

As shown in FIG. 2, the molds 21, 22 (a first mold and a second mold) to be adhered to each other are prepared first (step S4). In the embodiment, it is assumed that the mold will be reused after being used. Therefore, molds manufactured with use of the water glass as binder are employed as the molds 21, 22. This means that, with the molds manufactured with use of water glass as binder, reconditioned sand can be generated as treatment of removing the water glass is performed after the mold is used, and the reconditioned sand can be reused.

Thereafter, the mold adhesive 15 manufactured by the foregoing manufacturing method is applied to at least one of an adhering surface 31 of the mold 21 and an adhering surface 32 of the mold 22 (step S5). In the example shown in FIG. 2, the mold adhesive 15 is applied to the adhering surface 31 of the mold 21. The mold adhesive 15 may be applied to the adhering surface 32 of the mold 22, and may also be applied to both of the adhering surface 31 of the mold 21 and the adhering surface 32 of the mold 22.

Thereafter, the adhering surface 31 and the adhering surface 32 are closely fitted to each other and dried for a given period of time, and the mold 21 and the mold 22 are thus adhered to each other (step S6). Thus, it is possible to manufacture the mold 20.

The drying time may be, for example, about 30 seconds to 1 minute, but not limited to this. The adhering step in step S6 can be performed typically at normal temperature. As the adhering step is performed at normal temperature as described above, equipment for heating is not necessary, and the adhering step for the molds is performed easily.

In the embodiment, in the adhering step of step S6, provision of separate simple equipment that promotes drying of the mold adhesive 15 shall not be prevented as long as drying of the mold adhesive 15 can be promoted with use of the simple equipment.

As described so far, with the disclosure according to the embodiment, the mold adhesive is manufactured with use of the aqueous solution containing the water glass. Since the aqueous solution containing the water glass is aqueous solution that contains the water glass only (the aqueous solution may also contain inevitable impurities), the manufactured mold adhesive contains only components of water glass and water (this means that the manufactured mold adhesive does not contain impurities such as organic substances). Therefore, when the mold is reused after being used, it is possible to generate reconditioned sand as the treatment of removing the water glass is performed.

This means that, since impurities (such as organic substances) other than the water glass are not contained, treatment of removing the impurities other than the water glass is not necessary, and the reclamation treatment for the mold is easily performed.

Further, with the disclosure according to the embodiment, when castings are adhered to each other, the mold adhesive (the gelled water glass) manufactured with use of the water glass is used instead of mere use of the water glass. This means that, when the water glass is used as the adhesive, thermal treatment for thermally curing the water glass is necessary when the molds are adhered to each other. Meanwhile, with the disclosure according to the embodiment, the thermal treatment is not necessary as the castings are adhered to each other with use of the mold adhesive (the gelled water glass) manufactured with use of the water glass.

To be more specific, when the water glass is used as the adhesive, the thermal treatment is necessary because it is necessary to cause the dehydration condensation reaction of the water glass so as to cure the water glass. Meanwhile, with the disclosure according to the embodiment, when the mold adhesive (the gelled water glass) manufactured with use of the water glass is used, the thermal treatment is not necessary because the molds are adhered to each other as the mold adhesive is dried at normal temperature. Therefore, it is possible to simplify the adhering step for the molds.

As described so far, with the disclosure according to the embodiment, it is possible to provide the manufacturing method for the mold adhesive, the manufacturing method for the mold, and the mold by which the reclamation treatment for the mold is performed easily, and the adhering step for the molds is performed easily.

The disclosure has been described with reference to the embodiment of the disclosure. However, the disclosure is not limited to the configuration of the embodiment, and it is obvious that the disclosure includes various deformations, corrections, and combinations that can be made by a person skilled in the art without departing from the scope of the claims of the application.

What is claimed is:

1. A manufacturing method for a mold adhesive, the manufacturing method comprising:
a step of preparing aqueous solution containing water glass;
a step of heating the aqueous solution to 90° C. or higher but not exceeding 100° C.; and
a step of extracting gelled water glass as the mold adhesive, the gelled water glass being separated on a liquid surface of the heated aqueous solution, wherein a solid component of the prepared aqueous solution falls within a range of 25 mass % or higher but not exceeding 35 mass %.

2. The manufacturing method according to claim 1, wherein the solid component of the prepared aqueous solution falls within a range of 28 mass % or higher but not exceeding 32 mass %.

3. The manufacturing method according to claim 1, wherein, in the heating step, the aqueous solution is heated in a state where the liquid surface of the aqueous solution is in contact with air.

4. The manufacturing method according to claim 1, wherein the aqueous solution is prepared as water glass No. 3 specified in JISK1408 is diluted with water.

5. A manufacturing method for a mold, the manufacturing method comprising:
a step of preparing a first mold and a second mold manufactured with use of water glass as binder;
a step of applying the mold adhesive to at least either a first adhering surface of the first mold or a second adhering surface of the second mold, the mold adhesive being manufactured with use of the manufacturing method for the mold adhesive according to claim 1; and
a step of manufacturing the mold in which the first adhering surface and the second adhering surface are closely fitted to each other and dried for a given period of time so that the first mold and the second mold are adhered to each other.

6. A mold manufactured with use of the manufacturing method for the mold according to claim 5.
